(19) United States
(12) Patent Application Publication
(10) Pub. No.: US 2015/0347094 A1
(43) Pub. Date: Dec. 3, 2015

(54) INTERACTIVE LEARNING TOOL USING PLAYGROUND

(71) Applicant: Apple Inc., Cupertino, CA (US)

(72) Inventors: Christopher Arthur Lattner, Los Gatos, CA (US); Donald Matthew Firlik, Cupertino, CA (US); Katherine Blake Stone, Santa Cruz, CA (US); Kenneth Scott Orr, Morgan Hill, CA (US); Michael S. Ferris, Sunnyvale, CA (US); Tim V. Isted, Los Gatos, CA (US); Maxwell Oliver Drukman, San Francisco, CA (US)

(21) Appl. No.: 14/724,726

(22) Filed: May 28, 2015

Related U.S. Application Data
(60) Provisional application No. 62/005,868, filed on May 30, 2014.

(51) Int. Cl. G06F 9/44; G06F 11/36; G06F 9/45

(52) U.S. Cl. CPC G06F 8/30; G06F 8/34; G06F 8/41; G06F 11/3688; G06F 11/3692; G06F 8/42; G06F 8/43

(57) ABSTRACT

The subject disclosure relates to methods and systems for facilitating software development. In particular, aspects of the technology relate to a method including steps for receiving source code from a user in an editor window, automatically compiling the source code to produce compiled code, and executing the compiled code to generate an output, wherein the output comprises one or more results from execution of the compiled code. In some aspects, the method can also include steps for providing a results window to the user, the results window displaying at least one of the results from the execution of the compiled code, and providing a visualization window to the user, wherein the visualization window is associated with a progress timeline and wherein the visualization window is configured to display an animation of the at least one of the results from execution of the compiled code.

### CROSS-REFERENCE TO RELATED APPLICATIONS

This application claims the benefit of U.S. Provisional Application No. 62/005,868, filed May 30, 2014, entitled “INTERACTIVE LEARNING TOOL USING PLAYGROUND,” which is incorporated herein by reference in its entirety.

### BACKGROUND

1. Technical Field

The subject technology relates to methods, systems and computer-readable media for facilitating application development, and in particular for providing feedback and suggestions for source code developers.

2. Introduction

Many modern programming languages require advanced editing and compiling software in order to edit, debug and compile source code. In some development environments, a user (i.e., a developer or programmer) must engage in several manual steps before testing new code. For example, in a typical development lifecycle, source code must be separately edited, compiled, and run (executed) before debugging can commence.

### SUMMARY

In certain aspects, the disclosed subject matter relates to a computer-implemented method, including steps for receiving source code from a user in an editor window, automatically compiling the source code to produce compiled code, executing the compiled code to generate an output, wherein the output includes one or more results from execution of the compiled code, and providing a results window to the user, the results window displaying at least one of the results from the execution of the compiled code. In some aspects, the method can further include steps for providing a visualization window to the user, wherein the visualization window is associated with a progress timeline and wherein the visualization window is configured to display an animation of the at least one of the results from execution of the compiled code.

In another aspect, the disclosed subject matter relates to a system including one or more processors, and a computer-readable medium comprising instructions stored therein, which when executed by the processors, cause the processors to perform operations including receiving source code from a user in an editor window, automatically compiling the source code to produce compiled code, automatically executing the compiled code to generate an output, wherein the output comprises one or more results from execution of the compiled code, and providing a results window to the user, the results window displaying at least one of the results from the execution of the compiled code. In some aspects, the instructions can further include providing a visualization window to the user, wherein the visualization window is associated with a progress timeline and wherein the visualization window is configured to display an animation of the at least one of the results from execution of the compiled code.

In yet another aspect, the disclosed subject matter relates to a computer-readable medium including instructions stored therein, which when executed by a processor, cause the processor to perform operations including, receiving source code from a user in an editor window, automatically compiling the source code to produce compiled code, automatically executing the compiled code to generate an output, wherein the output comprises one or more results from execution of the compiled code, and providing a results window to the user, the results window displaying at least one of the results from the execution of the compiled code. In some aspects, the instructions can further include providing a visualization window to the user, wherein the visualization window is configured to display an animation of the at least one of the results from execution of the compiled code.

It is understood that other configurations of the subject technology will become readily apparent to those skilled in the art from the following detailed description, wherein various configurations of the subject technology are shown and described by way of illustration. The subject technology is capable of other and different configurations and its several details are capable of modification in various respects without departing from the scope of the subject technology. Accordingly, the detailed description and drawings are to be regarded as illustrative and not restrictive in nature.

### BRIEF DESCRIPTION OF THE DRAWINGS

Certain features of the subject technology are set forth in the appended claims. However, the accompanying drawings, which are included to provide further understanding, illustrate disclosed aspects and together with the description serve to explain the principles of the subject technology. In the drawings:

FIG. 1A illustrates steps of an example method for facilitating code editing, compiling and debugging, according to some aspects of the disclosure.

FIG. 1B illustrates steps of an example method for providing a progress timeline, corresponding with an animated output, according to some aspects of the technology.

FIGS. 2A-2D illustrate example displays provided in conjunction with a code editor, according to some aspects.

FIG. 3 illustrates an example of an electronic system with which some aspects of the technology can be implemented.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a more thorough understanding of the subject technology. However, it will be clear and apparent that the subject technology is not limited to the specific details set forth herein and may be practiced without these details. In some instances, structures and components are shown in block diagram form in order to avoid obscuring the concepts of the subject technology.

One inconvenience plaguing modern software development is that newly created (or newly edited) code must be manually compiled and run before results can be reviewed, at which point debugging is performed. For purposes of testing even small amounts of source code, this development lifecycle can prove to be cumbersome and time-consuming. Accordingly, a more convenient means of editing, testing, and debugging is desired.

Aspects of the subject technology address the foregoing problem by providing methods and systems for automatically editing, supplementing and compiling programming source code. Aspects of the technology also implement real-time visualizations and displays that provide outputs for certain variables and results of code execution, concurrent with code execution.

In some implementations, an application-based programming environment is provided in which source code may be received from a programmer/developer, and automatically edited and compiled for further review. As discussed in further detail below, relevant and/or interesting aspects of the code execution can be automatically displayed to the user, for example, in a results window provided in conjunction with an editor interface, or in a visualization window in which real-time animated variable outputs can be viewed. Additionally, developer guidance and/or suggestions can be provided, for example, to assist the user in correcting or completing source code statements.

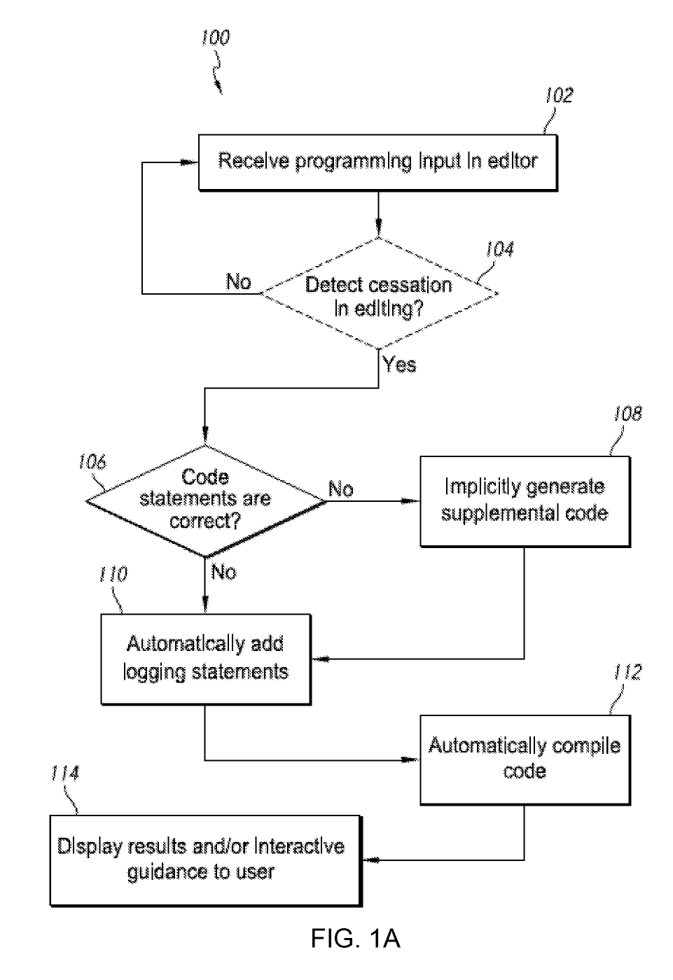

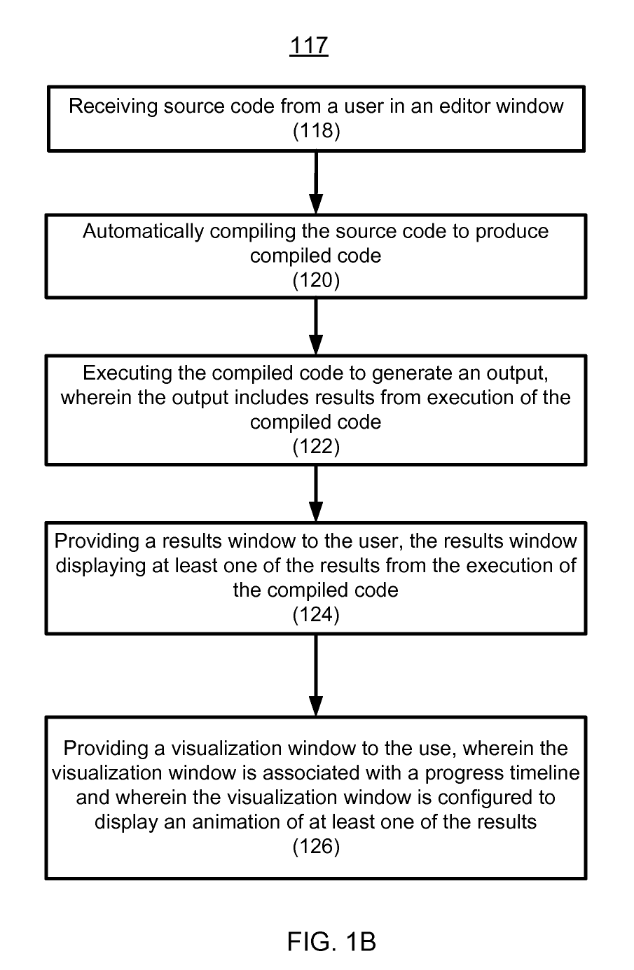

FIG. 1A illustrates a flowchart of an example method 100 for editing, compiling, and running source code. Method 100 begins with step 102, in which source code input (or programming code) is received from a user (e.g., a developer or programmer), for example, in an editor window provided by an editor application. It is understood that the editor application can be implemented with various programming languages and is not limited to a specific language. By way of example, the editor application can be an integrated development environment and can be used with object oriented programming (OOP) languages such as Swift, Objective-C, C++, Java, and/or MacRuby etc., or with languages of other types.

In practice, a user/programmer provides code (e.g. by typing) into an editor window interface of the editor application. Although code input may be received by the editor application using an input device, such as a keyboard, other input means can be used without departing from the scope of the subject disclosure. By way of example, source code can also be received via a microphone (e.g., using dictation software modules), and/or may be loaded from one or more pre-existing files. In another embodiment, source code can be received by an editor application through another input device, such as a computer mouse that is used to copy (or cut) and paste one or more lines of source code into the editor window.

In optional step 104, a state of the user's code entry is evaluated, for example to identify any cessation or pauses in code entry that may indicate opportune times in which entered code can be evaluated. Although in some aspects, evaluation of source code is performed in response to detecting code entry or editing (as in optional step 104), other events can also trigger code evaluation. For example, code evaluation can be performed in response to manual selections made by the user and/or may be automatically performed after predetermined time periods. By way of further example, code evaluation may be triggered by the occurrence of an event (or detected non-occurrence of an event), such as upon a determination that a predetermined threshold of code entry (such as a number of lines or functional statements) has been exceeded or met. In this manner, code evaluation can be performed automatically, i.e., without explicit instruction from the user that code evaluation/compiling should be performed.

If in optional step 104 it is determined that the user is continuing to enter/edit code in the editor window of the editor interface, method 100 reverts to step 102, and the editor application continues to receive source code input. If however, in step 104 it is determined that the user has stopped entering/editing code in the editor application, method 100 proceeds to step 106 in which the entered code statements are evaluated. Alternatively, in some implementations, the advance of method 100 may be predicated on the detection of complete or compilable code statements. In some aspects, step 104 may be skipped entirely, that is, entered code may be automatically evaluated, for example as described by steps 106-112, e.g., on an ongoing basis.

Code evaluation can be performed in various ways. In one approach, entered code can be evaluated for syntax, semantics and/or functional completeness and accuracy. Syntactic errors, such as typographic errors or errors in language mechanics can be identified. Similarly, the accuracy and/or completeness of the code statements and functions can be evaluated, and errors or missing code may also be identified. If it is determined in step 106 that the code statements of the received source code are inadequate or incorrect, then method 100 proceeds to step 108 in which the editor application can automatically generate supplemental code that may be needed to rectify syntactic or semantic errors identified in step 106.

Supplemental code generated in step 108 can be used to augment the programmer's source code to fix incomplete or erroneous code syntax. Similarly, supplemental code may be used to fix semantic deficiencies such as logically inaccurate (or incomplete) statements and/or functions. With the addition of supplemental code (or the removal of extraneous statements), the source code can be placed in condition for automatic compiling, as further described below.

As discussed in greater detail below, supplemental code may be displayed, for example, using a results window and or visualization window that is provided to the user/developer. In this manner, supplemental code may be provided to the developer, e.g., to inform or instruct the developer regarding ways in which the source code may be improved and/or corrected.

Subsequently, in step 110 the editor application automatically generates logging statements that are inserted at various locations in the source code. Such logging statements represent an additional form of supplemental code generated by the editor application. As understood by those of skill in the art, logging statements, including print/return statements, can be used to provide outputs for corresponding code lines (e.g., at runtime). In certain aspects, the insertion of supplemental code, including print or return statements, can be used to show the user/programmer what values or outputs are being produced at various locations (e.g., line locations) in the code.

In some aspects, supplemental code, including logging statements, may be inserted into an intermediate representation of the source code (e.g., a copy of the source code, bit code, byte code or LLVM IR), such that changes or additions are not automatically made to the originally entered source code without user acknowledgement.

In step 112, the source code, including augmented supplemental code generated at step 108 and/or step 110, is automatically compiled and/or run (executed). The compiling performed in step 112 can be performed as a background operation of the editor application and not explicitly indicated to the user. In such approaches, the evaluation/compilation of code, including augmented supplemental code, is automatically performed without explicit instruction from the user. Various outputs (and intermediary results) from the compiling of step 112 can be logged as information that is potentially of interest to the programmer. By way of example, items of interest for logging can include: declarations of variables, variable assignments, class declarations, objects, and/or target functions, etc.

In step 114, results of the source code execution and/or interactive guidance are provided to the user/programmer, for example, in a display window provided by the editor application. In some aspects, the display window can include a results window illustrating certain alphanumeric outputs (e.g., from one or more variables and for one or more lines of code). Additionally, the display window may include a visualization window in which results of the code execution can be displayed or animated. By way of example, the visualization window may be used to indicate changes in a particular variable and/or parameter, or to display graphical or video content produced/outputted by the code execution. Several of the examples provided herein relate to the use of the visualization window to provide animated outputs, however, it is understood that the visualization window is not limited to animated displays. Rather, the visualization window can be used to graphically represent dynamic changes to any variables, outputs and/or code functions that are capable of graphical representation. By way of example, the visualization window may be used to display a graph (e.g., in X, Y coordinate space) or to display a list of different values that a particular result assumes over time.

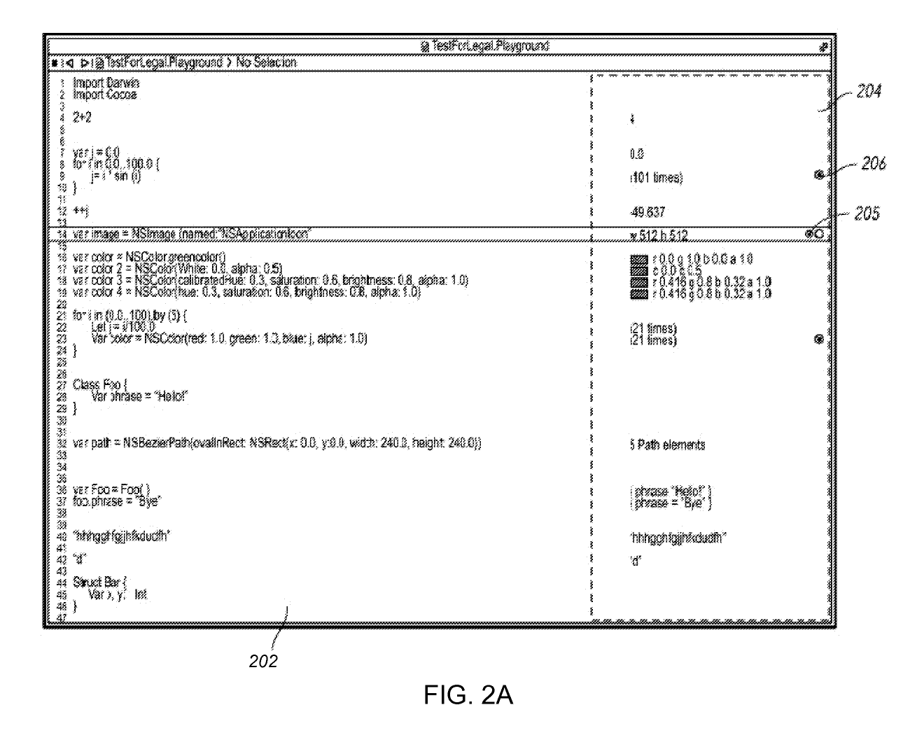

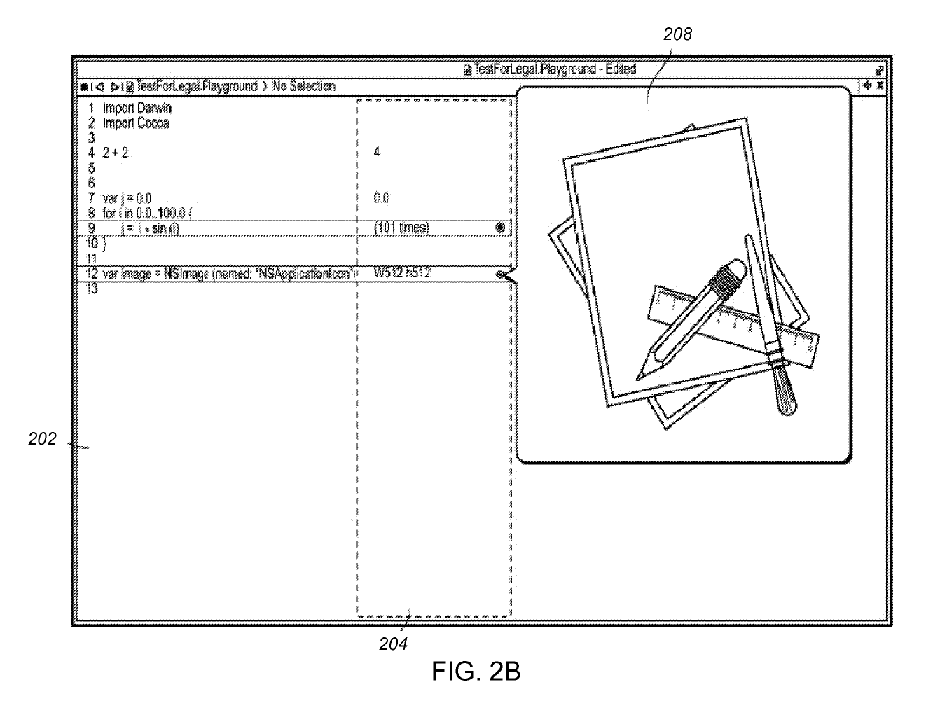

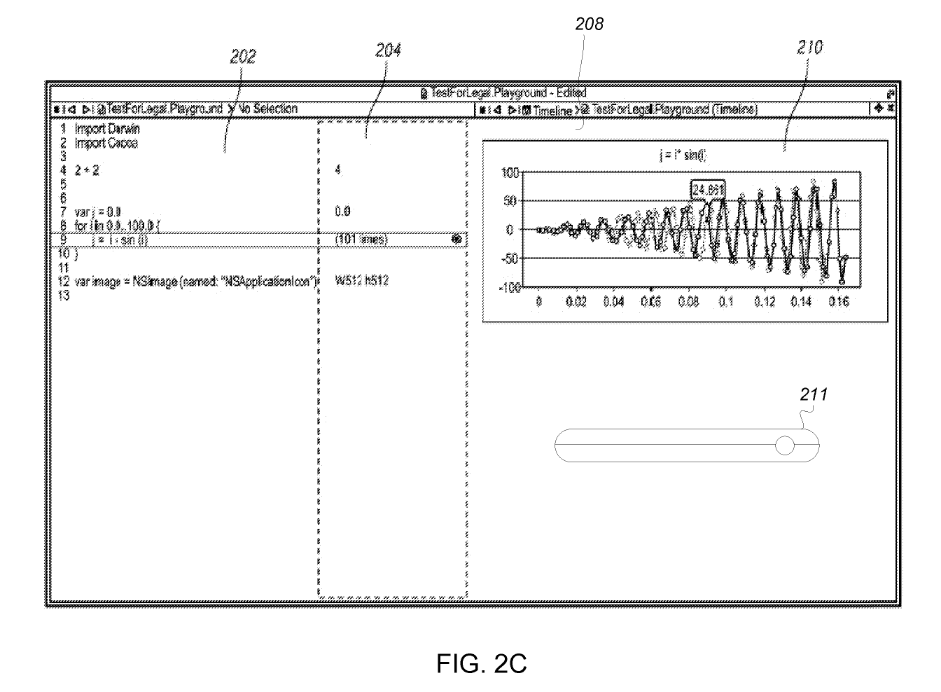

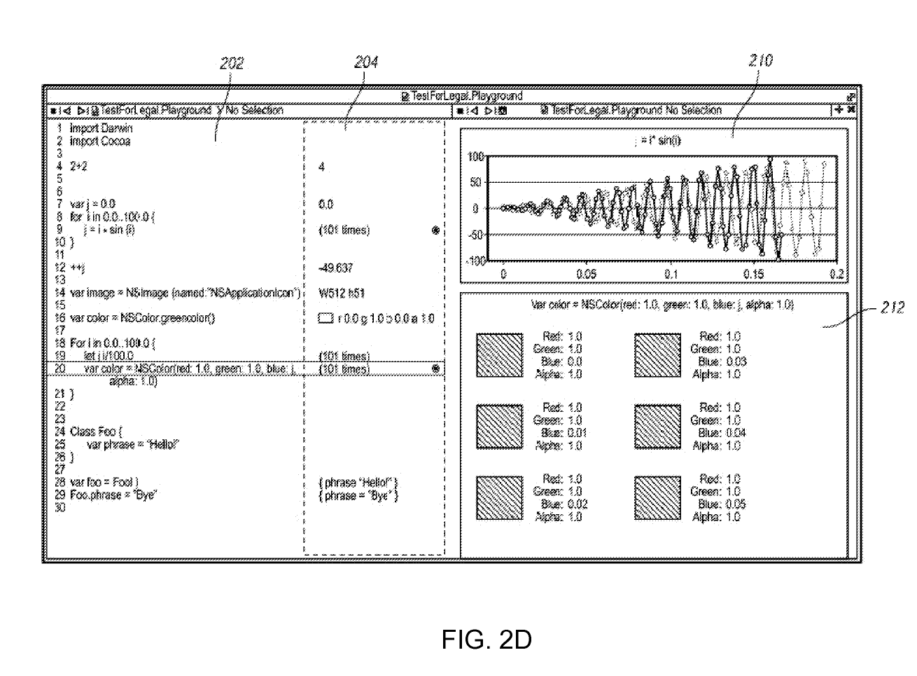

Although outputs for the source code can be provided to the programmer in various ways, in some implementations results of code execution are provided in a common window, such as the results window, of the editor application. In some approaches, results/outputs displayed in the results window are provided adjacent to the editor window in which the source code was entered/received from the user. That is, the results/outputs for a particular line of source code, or multiple lines/statements, can be displayed in a correspondingly adjacent manner to the associated code, for example, to indicate corresponding outputs or results. Further examples of editor application displays, including a results window and a visualization window, are discussed in further detail below with respect to FIGS. 2A-2D.

Additionally, in some implementations the display of step 114 is for use in providing interactive feedback or suggestions to the user/programmer, for example, to correct or augment portions of user-entered source code. For example, a user that is experimenting with, or learning a new programming language, can benefit from interactive guidance provided in the display window of the editor application display.

The output/display generated in step 114 (e.g., the display window) can provide instructional guidance such as code snippets, or plain-language descriptions pertaining to the functional or syntactic mechanics of corresponding code. The display window may also be used to provide suggestions for additional code, including functional statements that may be used to correct, complete, and/or optimize the received source code.

Results and/or guidance provided to the user may be temporarily available, independently of further edits/changes to corresponding source code. For example, results from a first iteration of code editing may be visually reduced (e.g., “grayed out”) to show that a particular result or output is no longer related to the current iteration of code. In this matter, a user/developer can be quickly provided with feedback indicating changes that have occurred in response to recent edits or changes.

Additionally, the manner in which certain results are provided, for example, in one or both of a results window and/or a visualization window, can depend on the data-type of the associated output. By way of example, alphanumeric data can be displayed in the results window adjacent to one or more corresponding lines of code. Alternatively, image outputs (e.g., JPEG, TIFF, PNG, etc.), or video outputs (e.g., QuickTime File Format, MPEG4, AVI, and/or WebM formats, etc.) may be provided in the visualization window.

FIG. 1B illustrates steps of an example method 117 for providing a progress timeline, corresponding with an animated output, according to some aspects of the technology. As will be discussed in further detail below, the editor application of the subject technology can be configured to provide an animated output of results achieved by execution of the received source code. In some implementations, the animated display is provided in conjunction with a timeline slider (i.e., a “progress timeline”) that provides a visual indication of an amount of time elapsed/remaining for the animated display of the respective variable output. As indicated in FIG. 1B, method 117 begins with step 118 in which source code is received (e.g., from a user) in an editor window of a code editor application. As discussed above with respect to step 102 of method 100, source code may be received in the editor window using an input device, such as a keyboard, or another input means such as a microphone (e.g., using dictation software modules).

In step 120, the received source code is automatically compiled to produce compiled code. Although in some aspects the decision to automatically compile received source code can be contingent upon the occurrence (or non-occurrence) of certain events, compiling can also proceed automatically on an ongoing basis, or upon detection of a threshold level of completeness for entered code statements or functions.

In step 122, the compiled code is executed to generate an output that includes results from execution of the compiled code. It is understood that the results can be based on variables or functions of different types. Accordingly, individual results can include different data-types, such as, alphanumeric data, sounds, and/or images such as graphs or pictures. Additionally, output results can include sequences of visually represented data that may be displayed as video outputs, i.e., as an animated sequence or film, etc.

In step 124, at least some of the results are provided using a results window. As discussed in further detail with respect to FIG. 2A, the results window can be used to display outputs that are formatted using alphanumeric characters. By way of example, the results window can be used to display numeric outputs, for example to indicate variable values or calculations which result from a corresponding line of source code.

In step 126, a visualization window is provided, wherein the visualization window is associated with a progress timeline and configured to display an animation of at least one of the results. As discussed in further detail below, the visualization window can be used to display images, video, and/or animated representations of data generated or modified by the source code. In some aspects, the progress timeline can be used to provide a real-time indicator of the timeframe in which an animated scene is played. Visual aspects relating to an animated output displayed by the visualization window can depend on data-types and/or function types for the corresponding source code.

The progress timeline can be used to scrub through a display of the execution for the corresponding animation. By way of example, a graphical output corresponding to a graph plot can be accelerated or reversed through manipulation of the progress timeline. That is, a user may view different execution points for a corresponding graphical output by manipulating a slider of the progress timeline, as will be explained further with respect to FIG. 2C, discussed below.

In some aspects, when working with visual elements, a user/developer can indicate a selection that will cause a chosen element or variable to be displayed upon execution. By way of example, multiple elements or set points in source code can be displayed chronologically according to a timeline, such that results/outputs for each selected element is provided upon execution.

FIG. 2A illustrates an example interface of an editor application 200, according to some aspects of the technology. Editor application 200 includes editor window 202 and results window 204. In the illustrated example, results window 204 includes various functional options, including quick-look button 205, and circle-icon 206.

In practice, programming code is received by an editor application via entry into editor window 202 (e.g. by a developer/programmer), and line-by-line results corresponding with output values of the entered code are provided in results window 204. As discussed above with respect to method 100, the results/outputs provided in results window 204 are automatically generated from compiliable code entered into editor window 202. Although the display of corresponding result/outputs can be performed in various ways, for example, depending on preferred user configurations, in some aspects the results are displayed adjacent to the source code that produces the result/output, indicating respective results/outputs on a line-by-line basis. For example, in FIG. 2A, the expression ‘2+2,’ (provided on line 4 of the editor window 202) corresponds with an adjacently displayed output (i.e., the number ‘4’) in results window 204.

Other data output types can be provided to the user. For example, variable results of other types, such as images or colors, can be displayed in results window 204, or in another display window such as a visualization window as discussed in greater detail, below. Quick-look button 205 can be used to indicate that an image or animated video output is available. Circle icon 206 can indicate that the results of a programming loop or repeating function, such as a graph, are available for display. In each instance, user interaction with either quick-look button 205 and/or circle icon 206 can cause the display of additional information regarding a particular output and/or line of executable code. For example, selection of quick-look button 205 or circle icon 206 can cause the opening of a visualization window configured to display images or animated outputs.

FIG. 2B illustrates another example of the interface of editor application 200. In the example depicted by FIG. 2B, quick-look icon 205 has been selected, resulting in the display of visualization window 208, which provides an image output for the corresponding source code. Depending on data-type, graphical outputs, such as that provided by visualization window 208 using various color swatches or aesthetic schemes.

FIG. 2C illustrates graph 210 that is displayed in a visualization window 208 of editor application 200 in response to a selection of circle icon 206, in results window 204. In this example, graph 210 displays the result of the loop for source code lines 7-10. In the example of FIG. 2C, visualization window 208 further includes timeline slider 211, that provides a temporal indication of the relative completeness for an animated display corresponding with a particular output.

By way of example, in the example of FIG. 2C, timeline slider 211 indicates a relative completeness of the animated output of the graph function depicted by graph 210. In this example, the user may forward or reverse timeline slider 211, for example, to rewind or accelerate execution of code corresponding with the display of graph 210.

In another aspect, timeline slider may indicate a maximal time lapse during code execution (e.g., the slider may be disposed to right side). That is, timeline slider 211 can represent the furthest temporal progress point for code being actively executed. Once code execution is complete, timeline slider 211 may be manipulated by a user, for example, to rewind the contents of results window 204 and/or visualization window 208 to an earlier execution point.

FIG. 2D illustrates yet another example of editor application 200 functionality. In this example, a variable display 212 is used to provide color changes over time (e.g., in selection of the ‘var color’ variable of source code line 20). Although the foregoing descriptions provide examples of various output types (e.g., variable values, image output, and visual representations of code functions), the subject technology is not limited to these output types. Rather, any useful information that might be provided to the user/programmer, e.g., including sound information, or other types of visual information are contemplated by the subject disclosure.

It is further understood that source code associated output, such as quantitative results, images, graphs, sounds, and/or source code suggestions (or guidance), may be provided in various ways to associate a particular result or outcome with corresponding code statements. By way of example, displays can be correlated with source code entry through adjacent or proximate placement of the results window, and/or through other visual devices, such as color schemes, and/or visually emphasizing (or minimizing) devices.

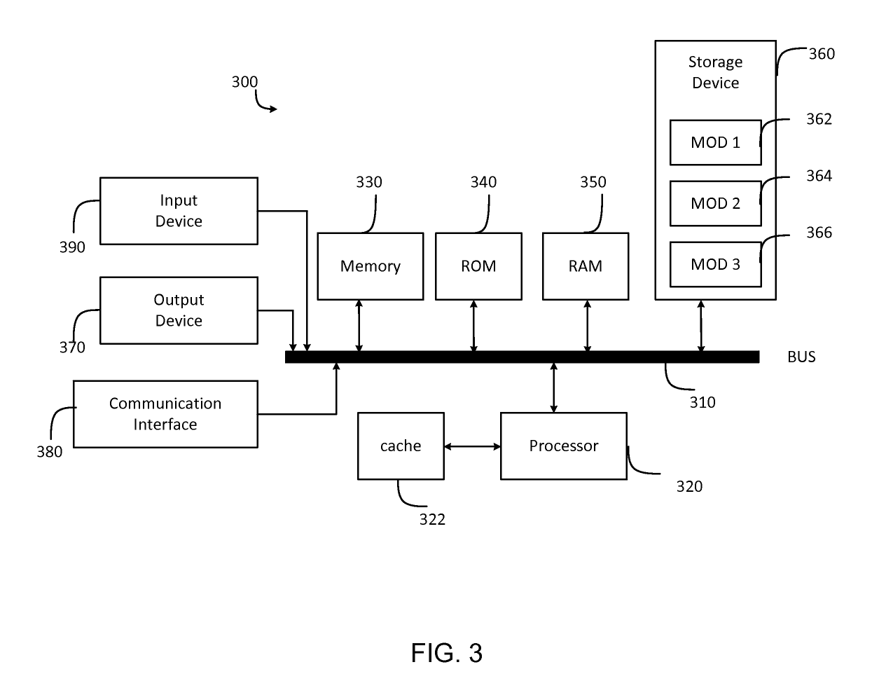

FIG. 3 illustrates an example of an electronic system with which some aspects of the subject technology can be implemented. As illustrated, system 300 includes a general-purpose computing device 300, including processing unit (CPU or processor) 320 and system bus 310 that couples various system components including system memory 330 (e.g., a computer-readable storage medium) such as read only memory (ROM) 340 and random access memory (RAM) 350 to processor 320. System 300 can include a cache 322 of high speed memory connected directly with, in close proximity to, or integrated as part of processor 320.

System 300 can copy data from memory 330 and/or storage device 360 to cache 322 for quick access by processor 320. In this way, cache 322 provides a performance boost that avoids processor 320 delays while waiting for data. These and other modules can control or be configured to control processor 320 to perform various actions. Other system memory 330 may be available for use as well. Memory 330 can include multiple different types of memory with different performance characteristics. It can be appreciated that the disclosure may operate on computing device 300 which includes more than one processor 320 or on a group or cluster of computing devices networked together to provide greater processing capability.

Processor 320 can include any general purpose processor and a hardware module or software module, such as module 1 362, module 2 364, and module 3 366 stored in storage device 360, configured to control processor 320 as well as a special-purpose processor where software instructions are incorporated into the actual processor design. Processor 320 may essentially be a completely self-contained computing system, containing multiple cores or processors, a bus, memory controller, cache, etc. A multi-core processor may be symmetric or asymmetric.

System bus 310 may be any of several types of bus structures including a memory bus or memory controller, a peripheral bus, and a local bus using any of a variety of bus architectures. A basic input/output (BIOS) stored in ROM 340 or the like, can provide basic routines that help to transfer information between elements within computing device 300, such as during start-up. Computing device 300 can further include storage devices 360 such as a hard disk drive, a magnetic disk drive, an optical disk drive, tape drive or the like. Storage device 360 can include software modules 362, 364, 366 for controlling the processor 320. Storage device 360 is connected to system bus 310 by a drive interface. The drives and the associated computer readable storage media provide nonvolatile storage of computer readable instructions, data structures, program modules and other data for computing device 300.

In one aspect, a hardware module that performs a particular function includes the software component stored in a non-transitory computer-readable medium in connection with the necessary hardware components, such as processor 320, bus 310 and so forth, to carry out the function. The basic components are known to those of skill in the art and appropriate variations are contemplated depending on the type of device, such as whether the device 300 is a handheld computing device, such as a smart phone, or larger computing device, such as a desktop computer, or a computer server.

By way of example, processor 320 can be configured to execute operations for detecting an input state indicating that source code is being received from a user/programmer, detecting a change in the input state, the change indicating that the source code is no longer being received from the user, and in response to the change in the input state, automatically compiling the source code to produce compiled code. In some aspects, processor 320 can be further configured to perform operations for executing the compiled code to generate an output, wherein the output includes one or more results from execution of the compiled code, providing the output to the user.

Additionally, in some implementations, processor 320 can be configured for checking the source code received to determine if the source code is syntactically complete (or correct), and in an event that source code is syntactically incomplete, generating supplemental code and automatically augmenting the source code with the supplemental code.

In some implementations, processor 320 may also perform operations for checking the source code received from the user to determine if the source code is functionally complete, and in an event that source code is functionally incomplete, generating supplemental code; and automatically augmenting the source code with the supplemental code.

In some implementations, processor 320 may also perform operations for automatically adding one or more logging statements to the source code, and wherein the output includes information corresponding with at least one of the one or more logging statements.

In some implementations, processor 320 may also perform operations for displaying at least a portion of the output in a window adjacent to corresponding portions of the source code and/or displaying at least a portion of the output in an editor display together with the source code.

Although the exemplary embodiment described herein employs storage device 360, it should be appreciated by those skilled in the art that other types of computer readable media which can store data that are accessible by a computer, such as magnetic cassettes, flash memory cards, digital versatile disks, cartridges, random access memories (RAMs) 350, read only memory (ROM) 340, a cable or wireless signal containing a bit stream and the like, may also be used in the exemplary operating environment. Non-transitory computer-readable storage media expressly exclude media such as energy, carrier signals, electromagnetic waves, and transitory signals per se.

To enable user interaction with the computing device 300, an input device 390 represents any number of input mechanisms, such as a microphone for speech, a touch-sensitive screen for gesture or graphical input, keyboard, mouse, motion input, speech and so forth. An output device 370 can also be one or more of a number of output mechanisms known to those of skill in the art. In some instances, multimodal systems enable a user to provide multiple types of input to communicate with the computing device 300. The communications interface 380 generally governs and manages the user input and system output. There is no restriction on operating on any particular hardware arrangement and therefore the basic features here may easily be substituted for improved hardware or firmware arrangements as they are developed.

For clarity of explanation, the illustrative system embodiment is presented as including individual functional blocks including functional blocks labeled as a “processor” or processor 320. The functions these blocks represent may be provided through the use of either shared or dedicated hardware, including, but not limited to, hardware capable of executing software and hardware, such as a processor 320, that is purpose-built to operate as an equivalent to software executing on a general purpose processor. For example, the functions of one or more processors may be provided by a single shared processor or multiple processors. (Use of the term “processor” should not be construed to refer exclusively to hardware capable of executing software.) Illustrative embodiments may include microprocessor and/or digital signal processor (DSP) hardware, read-only memory (ROM) 340 for storing software performing the operations discussed below, and random access memory (RAM) 350 for storing results. Very large scale integration (VLSI) hardware embodiments, as well as custom VLSI circuitry in combination with a general purpose DSP circuit, may also be provided.

The logical operations of the various embodiments are implemented as: (1) a sequence of computer implemented steps, operations, or procedures running on a programmable circuit within a general use computer, (2) a sequence of computer implemented steps, operations, or procedures running on a specific-use programmable circuit; and/or (3) interconnected machine modules or program engines within the programmable circuits. The system 300 can practice all or part of the recited methods, can be a part of the recited systems, and/or can operate according to instructions in the recited non-transitory computer-readable storage media. Such logical operations can be implemented as modules configured to control the processor 320 to perform particular functions according to the programming of the module.

For example, FIG. 3 illustrates three modules Mod1 362, Mod2 364 and Mod3 366 that are modules configured to control the processor 320. These modules may be stored on the storage device 360 and loaded into RAM 350 or memory 330 at runtime or may be stored as would be known in the art in other computer-readable memory locations.

It is understood that any specific order or hierarchy of steps in the processes disclosed is an illustration of exemplary approaches. Based upon design preferences, it is understood that the specific order or hierarchy of steps in the processes may be rearranged, or that only a portion of the illustrated steps be performed. Some of the steps may be performed simultaneously. For example, in certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more.”

A phrase such as an “aspect” does not imply that such aspect is essential to the subject technology or that such aspect applies to all configurations of the subject technology. A disclosure relating to an aspect may apply to all configurations, or one or more configurations. A phrase such as an aspect may refer to one or more aspects and vice versa. A phrase such as a “configuration” does not imply that such configuration is essential to the subject technology or that such configuration applies to all configurations of the subject technology. A disclosure relating to a configuration may apply to all configurations, or one or more configurations. A phrase such as a configuration may refer to one or more configurations and vice versa.

The word “exemplary” is used herein to mean “serving as an example or illustration.” Any aspect or design described herein as “exemplary” is not necessarily to be construed as preferred or advantageous over other aspects or designs.

What is claimed is:

1. A computer-implemented method comprising:
receiving source code from a user;
automatically compiling the source code to produce compiled code;
executing the compiled code to generate an output, wherein the output comprises one or more results from execution of the compiled code;
displaying at least one of the results from the execution of the compiled code; and
displaying a visualization window to the user, wherein the visualization window displays an animation of the at least one of the results from execution of the compiled code.

2. The computer-implemented method of claim 1, further comprising:
displaying a progress timeline, wherein the progress timeline is configured to indicate progress of the animation displayed in the visualization window.

3. The computer-implemented method of claim 2, wherein display of the animation is based on a data-type for at least one of the results from execution of the compiled code.

4. The computer-implemented method of claim 1, further comprising:
receiving a user selection indicating a display preference for one or more variables from the compiled code, and
wherein the animation displayed in the visualization window is based on the user selection.

5. The computer-implemented method of claim 1, wherein automatically compiling the source code further comprises:
checking the source code received to determine if the source code is syntactically complete;
in an event that source code is syntactically incomplete, generating supplemental code; and
providing at least a portion of the supplemental code to the user, wherein providing the supplemental code to the user is performed automatically without input from the user.

6. The computer-implemented method of claim 1, wherein automatically compiling the source code further comprises:
checking the source code received from the user to determine if the source code is functionally complete;
in an event that source code is functionally incomplete, generating supplemental code; and
displaying at least a portion of the supplemental code in the results window.

7. The computer-implemented method of claim 1, wherein automatically compiling the source code further comprises:
generating an intermediate representation of the source code; and
automatically adding one or more logging statements to the intermediate representation of the source code, and wherein the output comprises information corresponding with at least one of the one or more logging statements.

8. The computer-implemented method of claim 1, wherein providing the results window to the user further comprises:
displaying the at least one of the results from execution of the compiled code in a position adjacent to one or more lines of the compiled code in the editor window.

9. The computer-implemented method of claim 1, wherein automatically compiling the source code further comprises:
detecting an input state, the input state indicating that source code is being received from the user in an editor window;
detecting a change in the input state, the change indicating that the source code is no longer being received from the user; and
compiling the source code in response to the change in the input state.

10. A system comprising:
one or more processors; and
a computer-readable medium comprising instructions stored therein, which when executed by the processors, cause the processors to perform operations comprising:
receiving source code from a user in an editor window;
automatically compiling the source code to produce compiled code;
automatically executing the compiled code to generate an output, wherein the output comprises one or more results from execution of the compiled code;
providing a results window to the user, the results window displaying at least one of the results from the execution of the compiled code; and
providing a visualization window to the user, wherein the visualization window is associated with a progress timeline and wherein the visualization window is configured to display an animation of the at least one of the results from execution of the compiled code.

11. The system of claim 10, wherein the progress timeline is configured to indicate progress of an animated sequence displayed in the visualization window, and wherein the animated sequence is based on the results from execution of the compiled code.

12. The system of claim 11, wherein display of the animated sequence is based on a data-type for at least one of the results from execution of the compiled code.

13. The system of claim 10, wherein automatically compiling the source code further comprises:
receiving a user selection indicating a display preference for one or more variables from the compiled code, and
wherein the animation displayed in the visualization window is based on the user selection.

14. The system of claim 10, wherein automatically compiling the source code further comprises:
checking the source code received to determine if the source code is syntactically complete;
in an event that source code is syntactically incomplete, generating supplemental code; and
providing at least a portion of the supplemental code to the user.

15. The system of claim 10, wherein automatically compiling the source code further comprises:
checking the source code received from the user to determine if the source code is functionally complete;
in an event that source code is functionally incomplete, generating supplemental code; and
displaying at least a portion of the supplemental code in the results window.

16. The system of claim 10, wherein automatically compiling the source code further comprises:
generating an intermediate representation of the source code; and
automatically adding one or more logging statements to the intermediate representation of the source code, and wherein the output comprises information corresponding with at least one of the one or more logging statements.

17. The system of claim 10, wherein providing the results window to the user further comprises:
displaying the at least one of the results from execution of the compiled code in a position adjacent to one or more lines of the compiled code in the editor window.

18. The system of claim 10, wherein automatically compiling the source code further comprises:
detecting an input state, the input state indicating that source code is being received from the user in the editor window;
detecting a change in the input state, the change indicating that the source code is no longer being received from the user; and
compiling the source code in response to the change in the input state.

19. A computer-readable storage medium comprising instructions stored therein, which when executed by one or more processors, cause the processors to perform operations comprising:
receiving source code from a user;
automatically compiling the source code to produce compiled code;
automatically executing the compiled code to generate an output, wherein the output comprises one or more results from execution of the compiled code;
and
providing a visualization window to the user, wherein the visualization window is configured to display an animation of the at least one of the results from execution of the compiled code.

20. The computer-readable storage medium of claim 19, wherein automatically compiling the source code further comprises:
checking the source code received to determine if the source code is syntactically complete;
in an event that source code is syntactically incomplete, generating supplemental code; and
displaying at least a portion of the supplemental code to the user.

21. A computer-implemented method comprising:
receiving source code from a user;
automatically compiling the source code to produce compiled code;
executing the compiled code to generate an output, wherein the output comprises one or more results from execution of the compiled code; and
providing the output to the user, wherein at least a portion of the output is displayed to the user in a display window.
